(19) United States
(12) Patent Application Publication
(10) Pub. No.: US 2002/0123323 A1
(43) Pub. Date: Sep. 5, 2002

(54) Method for providing call charge information in a telecommunication link

(76) Inventor: Jan Simal, Laarne (BE)

Correspondence Address: MORRISON & FOERSTER LLP, 2000 PENNSYLVANIA AVE, NW, SUITE 5500, WASHINGTON, DC, 20006-1888, US

(21) Appl. No.: 10/050,034

(22) Filed: Jan. 17, 2002

(30) Foreign Application Priority Data
Jan. 22, 2001 (DE) 10102724.9

(51) Int. Cl. H04M 11/00

(52) U.S. Cl. 455/406; 455/405; 455/408

(57) ABSTRACT

The invention relates to a method for providing call charge information in a telecommunication link between a calling subscriber with a first terminal and a called subscriber with a second terminal. The first terminal is connected to a first local telecommunication exchange and the second terminal is connected to a second local telecommunication exchange. Call charges arising for the telecommunication link are determined in the first telecommunication exchange and corresponding call charge information is sent as messages to the second telecommunication exchange to enable the call charge information to be used there in real time while the telecommunication link is in existence.

### CLAIM FOR PRIORITY

This application claims priority to Application No. DE 10102724 which was published in the German language on Jan. 22, 2001.

### TECHNICAL FIELD OF THE INVENTION

The invention relates to a method for providing call charge information in a telecommunication link between a calling subscriber with a first terminal and a called subscriber with a second terminal.

### BACKGROUND OF THE INVENTION

In a telecommunication link, such as a telephone call, a plurality of telecommunication exchanges which, among other things, are used for setting up, maintaining and terminating the link, are arranged between a first calling subscriber with a first terminal and a second called subscriber with a second terminal. Furthermore, the exchanges handle the determination of the call charges incurred for the telecommunication link on the basis of the relevant charging rates (time of day, duration, distance . . . ).

As a rule, the call charges for a single telephone call, accrued due to the utilization of a telephone network and of services provided by various service providers, are determined in the first local exchange which is allocated to the calling subscriber. The call charges can also be determined in another exchange via which the telephone call between the subscribers is conducted for switching purposes. Thus, for example in the case of an international call, the local exchange allocated to the calling subscriber forwards the call to an international exchange for outgoing international calls. The international exchange handles the determination of the call charges incurred for the telephone call. As soon as the call charges have been determined by the international exchange, these, or the charge rates, are sent back to the first local exchange allocated to the calling subscriber. This makes it possible for the local exchange to perform call charge accounting for the telephone call on-line. Furthermore, the local exchange can provide the calling subscriber with the service attribute of a call charge indication such as AOC (advice of charge) in order to enable the subscriber to continually check the call costs incurred in the form of call charges by means of an indication on his terminal.

The service attribute of fixing an upper limit for costs arising due to the telephone call (SCLS=subscriber credit limit supervision) can also be provided by the local exchange. The subscriber is thus provided with the capability of not allowing the accruing costs to exceed the upper limit by terminating the telephone call.

In the deregulated public telecommunication market, either the local operator allocated to the calling subscriber or the carrier can be responsible for providing the call charge information online/offline depending on the type of call. The question of who takes over the function of providing the call charge information, and thus of determining the call charges, is determined by the arrangement of the so-called charging determination point (CDP).

Depending on whether the charging determination point is allocated to the local operator or to the carrier which can also be allocated two different networks, it is either the local operator or the carrier who is responsible for determining the call charges. Thus, for example, a carrier can send his charge rate information back over network boundaries to the subscriber in order to illustrate his cheaper charges to the subscriber if he represents the charging determination point (CDP) for this telephone call. These call charges are then indicated on a display device of the first terminal of the calling subscriber and/or taken into consideration when an upper permissible limit for the credit (subscriber credit limit supervision—SCLS) of a subscriber is exceeded.

The abovementioned forms of cost indication and cost limitation are exclusively applied to telephone calls where the calling subscriber receives the cost account and only for as long as he pays for the telephone call. When the called subscriber has to pay for the costs of the telephone call, as is the case with reversed-charge calls, the sending of the call charge information from the exchange/the carrier (in which the CDP is arranged) back to the first exchange (which is allocated to the calling subscriber) is of little use since, in this case, cost accounting has to be handled by the second local exchange. Thus, the called subscriber cannot be offered an indication of costs and limitation of costs.

This results in an obvious problem, particularly for carriers specializing in operator-assisted telephone calls. If, for example, an operator-initiated call arrives at a coin telephone or a hotel telephone and it is not possible to send the charges determined for the telephone call to the calling subscriber, cost accounting with the coin telephone/hotel telephone is also not possible. Consequently, the operator-initiated calls for coin telephones or hotel room telephones are blocked by the operator and the normal subscribers are informed that AOC and SCLS cannot be offered as service attributes for these calls.

Since transmission of the call charge information from the carrier to the local exchange which is allocated to the called subscriber is not possible in reversed-charge calls, the local exchange determines the call costs on the basis of a model which assumes that the call has been initiated by the called subscriber. The corresponding costs are then used for using the AOC and SCLS service attributes. Since, the charges determined are based on assuming that the call has been initiated by the called subscriber, it may not be possible to determine the real charges incurred. Charge accounting thus takes place at the wrong level of costs.

### SUMMARY OF THE INVENTION

In one embodiment of the invention, there is a system for providing call charge information in a telecommunication link between a calling subscriber and a called subscriber. The system includes, for example, a first terminal connected to a first local telecommunication exchange, and a second terminal connected to a second local telecommunication exchange, wherein call charges arising for the telecommunication link are determined in the first telecommunication exchange and corresponding call charge information is sent as messages to the second telecommunication exchange such that the call charge information is configured for use in real time while the telecommunication link is in existence.

In one aspect of the invention, the call charge information is sent to the second telecommunication exchange as APM ISUP message to utilize services and service attributes.

In another aspect of the invention, the content of the APM ISUP message is determined by APPs.

In yet another aspect of the invention, the APPs comprise an application-independent part which includes information on the APM ISUP message, and an application-dependent part which includes user data relating to the call charge information.

In another aspect of the invention, the application-dependent part is coded, as ASE based on a data structure.

In another aspect of the invention, the call charge information sent creates a call charge account for the called subscriber in real time.

In still another aspect of the invention, the call charge information sent determines a threshold value with respect to an upper limit for the call charges to be taken over by the called subscriber.

In another aspect of the invention, the call charge information sent indicates the call charges on a display device of the second terminal while the telecommunication link is in existence.

In another embodiment of the invention, there is a method for providing call charge information. The method includes, for example, setting up a telecommunication link between first and second terminals of a calling and a called subscriber, respectively, sending a message with the call charge information from the first telecommunication exchange to the second telecommunication exchange, sending an acknowledgement signal for the acceptance of the call charges by the called subscriber from the second to the first telecommunication exchange, and terminating the telecommunication link between the calling and called subscribers by one of the subscribers or by a service attribute based on utilization of the call charge information.

In another aspect of the invention, the call charge information is sent to the second telecommunication exchange as APM message to utilize services and service attributes.

In another aspect of the invention, content of the APM ISUP message is determined by APPs.

In yet another aspect of the invention, the APPs comprise an application-independent part which includes information on the APM ISUP message, and an application-dependent part which includes user data relating to the call charge information.

In another aspect of the invention, the application-dependent part is coded, as ASE based on a data structure.

In another aspect of the invention, the call charge information sent creates a call charge account for the called subscriber in real time.

In still another aspect of the invention, the call charge information sent determines a threshold value with respect to an upper limit for the call charges to be taken over by the called subscriber.

In another aspect of the invention, the call charge information sent indicates the call charges on a display device of the second terminal while the telecommunication link is in existence.

### BRIEF DESCRIPTION OF THE DRAWINGS

In the text which follows, the invention will be described by means of an exemplary embodiment which is explained in greater detail with reference to the figure.

FIG. 1 shows an originating local exchange allocated to a calling subscriber, a terminating local exchange allocated to a called subscriber and a transit exchange arranged between these exchanges. The three exchanges can be arranged in a common network or in separate networks.

### DETAILED DESCRIPTION OF THE PREFERRED EMBODIMENTS

The present invention discloses a method of providing call charge information in a telecommunication link, which can supply more comprehensive and more correct call charge information.

In one embodiment, the call charges arising for the telecommunication link are determined in the exchange allocated to the first calling subscriber. Whereas, the call charge information corresponding to the charge for providing services and/or creating a cost account is handled in the exchange allocated to the second called subscriber. The call charge information is sent in the forward direction, that is from the exchange of the calling party to that of the called party. As a result, correct call charge accounting, among other things, is possible in real time for the called subscriber if he is to take over the costs. This is because the call charges are determined by the exchange which is allocated to the called subscriber.

The separation of call charge determination and creation of the call charge accounts between two different exchanges advantageously has the result that the called subscriber can also use service attributes such as AOC or SCLS. The service attributes used are then based on the call charge information which has really accrued during the telephone call.

The call charge data determined by the first local exchange are sent as messages to the second exchange during the existing telecommunication in order to create a call charge indication and a call charge account for the called subscriber in real time. The message can have the form of a generic APM (application transport message) ISUP (ISDN user part) message. The content of this message is determined by means of application transport parameters (APPs). In principle, these APPs include two parts irrespective of the application:

1. An application-independent part which is binary coded and includes general information on the meaning and handling of the message. This component is occupied by various fields, one of which is provided for determining the application for which the message is provided (Application Context Identifier). The application related to call charge accounts of telecommunication links is allocated the value 3.

2. An application-dependant part called ASE (Application Service Element) is coded, by using basic rules for describing a data structure (Basic Encoding Rules, BER), ASN.1.

The application-dependent component includes the actual user information (user data) for the application of call charge accounting, in this case, for transmitting the call charges or charge rates determined. For the call charge accounting application, this component exhibits three different variations called primitives as defined in European Standard ES 201 296: CRGT (Charging Tariff), AOCRG (Add-On Charge) and CRGA (Charging Acknowledgement). Which one of these primitives is to be included in the message will be indicated at the beginning of the ASE. Thus, standards which are already in existence can be advantageously used.

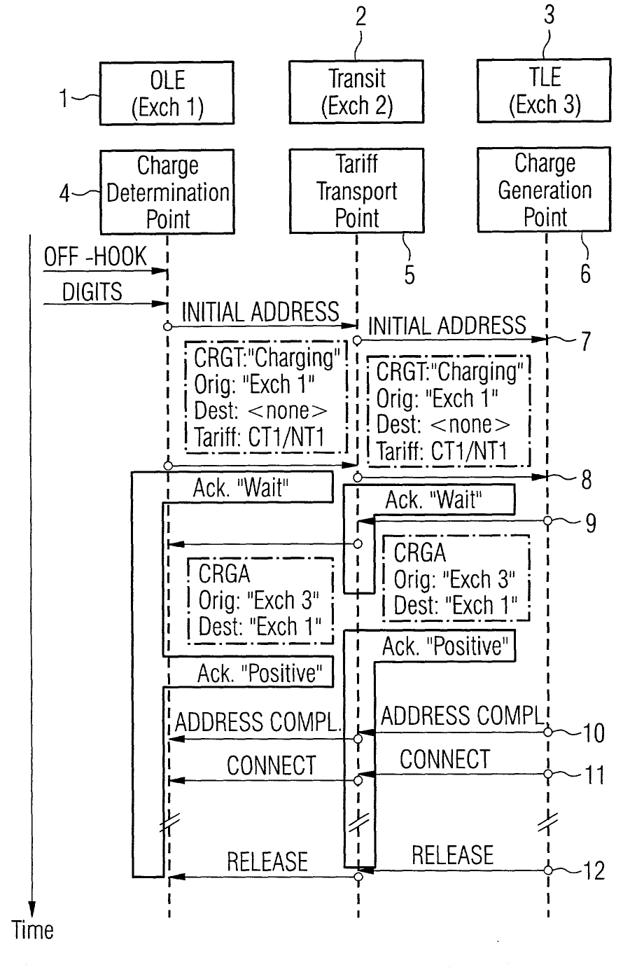

Referring to FIG. 1, a charge determination point (CDP) 4 is allocated to the originating local exchange 1. At this charge determination point, the charges accruing for the telecommunication link existing between the subscribers and thus the exchanges 1,2 and 3 are determined.

The call charges or charging rates determined are transmitted to the exchange 3 at a tariff transport point 5 which is allocated to the transit exchange 2. A charge generation point 6 which has the task of generating a call charge account for the called subscriber is allocated to this exchange 3.

As soon as the calling subscriber removes the handset and enters a particular number via the keypad in his terminal, an initial address is sent from exchange 1 to exchange 2 and onward to exchange 3 in a step 7. A message to which the initial address is allocated contains call charge information which includes the call charges determined by exchange 1. Exchange 1 is arranged in the network in which the charge determination point 4 is located.

The message is sent as APM message via the ISDN CCS7 user part (ISUP) to the exchange 3 which, together with the called subscriber, is arranged in a further network. The call charge information transmitted in this manner can be, among other things, the charging tariffs (CRGT) fixed by the first exchange 1.

Exchange 3 interprets the call charge information correspondingly in order to use it for setting up a call charge account in real time or for providing the service attributes AOC and/or SCLS. These service attributes can then be used by the called subscriber due to the fact that the call charge accounting is carried out in the exchange allocated to the called subscriber. In particular, the call charges accruing during a telephone call can be indicated.

At 9, the sending back of an acknowledgement signal (charging acknowledgement, CRGA) from the exchange 3 to exchange 1 indicates the readiness that the called subscriber will take over the costs of the telephone call. The actual telephone call is then begun in at 11 if the message has been sent from exchange 1 to exchange 3 before the actual beginning of the telephone call. In at 12, the telephone call is then terminated by replacing the handset.

The acknowledgement and confirmation of receipt of the call charge information message and thus that the costs will be taken over by the called subscriber is not a mandatory prerequisite for continuing the telephone call or beginning the telephone call. Instead, sending back such an acknowledgement signal depends on bilateral contractual determinations between the transmitter and the receiver, that is to say the exchanges and associated carriers.

If the called subscriber takes over the costs for the telephone call in the form of a reversed-charge call, the message with the call charge information included therein is sent at a time at which a facility message is sent from the originating exchange 1 to the terminating exchange 3. The call charge information message is thus transmitted at the time of a “transmission request” when the calling subscriber has applied for the reversed-charge call. If the called subscriber has applied for the reversed-charge call, the call charge information message is sent at the time of “transmission acceptance”.

In another embodiment, the terminating exchange 3, in interaction with the called subscriber, can determine itself whether the received call charge information is used or replaced by its own call charge information.

The method according to the invention, particularly the sending of the call charge information message from a first exchange to a second exchange does not require any change in the ES 201 296 standard. It is also conceivable to use the method according to the invention under the ITU-T Standard Q.736 and, at the same time, changing this standard.

At this point, it should be pointed out that all parts described above seen by themselves and in any combination, particularly the details shown in the drawing, are claimed as essential to the invention. Modifications of these are known to the expert.

What is claimed is:

1. A system for providing call charge information in a telecommunication link between a calling subscriber and a called subscriber, comprising:
a first terminal connected to a first local telecommunication exchange; and
a second terminal connected to a second local telecommunication exchange, wherein call charges arising for the telecommunication link are determined in the first telecommunication exchange and corresponding call charge information is sent as messages to the second telecommunication exchange such that the call charge information is configured for use in real time while the telecommunication link is in existence.

2. The system as claimed in claim 1, wherein the call charge information is sent to the second telecommunication exchange as APM ISUP message to utilize services and service attributes.

3. The system as claimed in claim 2, wherein content of the APM ISUP message is determined by APPs.

4. The system as claimed in claim 3, wherein the APPs comprise an application-independent part which includes information on the APM ISUP message, and an application-dependent part which includes user data relating to the call charge information.

5. The system as claimed in claim 4, wherein the application-dependent part is coded, as ASE based on a data structure.

6. The system as claimed in claim 1, wherein the call charge information sent creates a call charge account for the called subscriber in real time.

7. The system as claimed in claim 1, wherein the call charge information sent determines a threshold value with respect to an upper limit for the call charges to be taken over by the called subscriber.

8. The system as claimed in claim 1, wherein the call charge information sent indicates the call charges on a display device of the second terminal while the telecommunication link is in existence.

9. A method for providing call charge information, comprising:
setting up a telecommunication link between first and second terminals of a calling and a called subscriber, respectively;
sending a message with the call charge information from the first telecommunication exchange to the second telecommunication exchange;
sending an acknowledgement signal for the acceptance of the call charges by the called subscriber from the second to the first telecommunication exchange; and
terminating the telecommunication link between the calling and called subscribers by one of the subscribers or by a service attribute based on utilization of the call charge information.

10. The method as claimed in claim 9, wherein the call charge information is sent to the second telecommunication exchange as APM message to utilize services and service attributes.

11. The method as claimed in claim 10, wherein content of the APM ISUP message is determined by APPs.

12. The method as claimed in claim 11, wherein the APPs comprise an application-independent part which includes information on the APM ISUP message, and an application-dependent part which includes user data relating to the call charge information.

13. The method as claimed in claim 12, wherein the application-dependent part is coded, as ASE based on a data structure.

14. The method as claimed in claim 9, wherein the call charge information sent creates a call charge account for the called subscriber in real time.

15. The method as claimed in claim 9, wherein the call charge information sent determines a threshold value with respect to an upper limit for the call charges to be taken over by the called subscriber.

16. The method as claimed in claim 9, wherein the call charge information sent indicates the call charges on a display device of the second terminal while the telecommunication link is in existence.
